(19) United States
(12) Patent Application Publication
(10) Pub. No.: US 2006/0161337 A1
(43) Pub. Date: Jul. 20, 2006

(54) Route planning process

(76) Inventor: Ping-Chung Ng, Hong Kong (HK)

Correspondence Address: JACOBSON HOLMAN PLLC, 400 SEVENTH STREET N.W., SUITE 600, WASHINGTON, DC, 20004, US

(21) Appl. No.: 11/037,394

(22) Filed: Jan. 19, 2005

(51) Int. Cl. G01C 21/34

(52) U.S. Cl. 701/201

(57) ABSTRACT

In a process for determining a route from a predetermined starting point to a predetermined destination, firstly, weights are assigned to route segments interconnected at route nodes. At least a first weight relating to a first route segment is varied by querying at least a data source based on at least a second weight relating to a second route segment. The second route segment is prior to the first route segment in a consideration of the route from the starting point to the destination. Subsequently, the route is determined by using a route finding algorithm, the algorithm taking the weights into account.

### BACKGROUND

1. Field of the Invention

The present invention relates to methods for determining a route from a predetermined starting point to a predetermined destination.

2. Background of the Invention

Substantial effort has been exerted in the past and is continuing to be directed toward route planning between origins and destinations in a variety of networks. Such examples include directing traffic in a manner to facilitate travel by individuals between a wide variety of origin and destination combinations in an optimized amount of time, distance, cost or the combination thereof.

For example, U.S. Pat. No. 6,63,812, entitled “Method for Influencing Source Data for Determining a Route in a Navigation System,” issued on Oct. 14, 2003 and assigned to Robert Bosch GmbH, discloses a method for manipulating source data to determine a route from a predetermined starting point to a predetermined destination for a motor vehicle, airplane or ship, based on a digital database that includes predetermined route segments with correspondingly assigned nodes that interconnect respective route segments. Respective weights are assigned to the route segments and/or the nodes. According to the '812 patent, the weights are varied, as a function of external events such as traffic conditions at the time the shortest-path computation is executed, before a route finding algorithm determines the route.

Inaccuracy may exist with this method in that in the '812 patent the weights are determined statically without taking into consideration the possible dynamic variations of the weights. Take public transport planning for example, in FIG. 13, a user is to travel from starting point 101 to destination 103 via interchange point 105. The traveling time between point 101 and point 105 is 30 minutes, while the traveling time between point 105 and point 103 is 45 minutes before 8:30 am but will decreases to 30 minutes after 8:30 am. Assuming the user is to leave point 101 at 8:15 am. According to the algorithm of the '812 patent, the calculated total traveling time from point 101 to point 103 via point 105 would be 75 minutes. But the actual total traveling time is 60 minutes indeed. This inaccuracy occurs in that the algorithm of the '812 patent calculates the traveling time based on the information at the time of calculation, i.e., 8:15 am, and at this time, the algorithm considers the traveling time between point 105 and point 103 to be 45 minutes. In reality, when the user reaches point 105, it is 8:45 am already, and the traveling time between point 105 and point 103 has decreased to 30 minutes. The algorithm of the '812 patent ignored the possible decrease in the traveling time between point 105 and 103 when it executes the calculation.

### OBJECT OF THE INVENTION

Therefore, it is an object of the present invention to provide an improved route planning method, which may simulate the real situation more accurately, or at least provide the public with a useful choice.

### SUMMARY OF THE INVENTION

According to an aspect of the present invention, in a process for determining a route from a predetermined starting point to a predetermined destination, firstly, weights are assigned to route segments interconnected at route nodes. At least a first weight relating to a first route segment is varied by querying at least a data source based on at least a second weight relating to a second route segment. The second route segment is prior to the first route segment in a consideration of the route from the starting point to the destination. Subsequently, the route is determined by using a route finding algorithm, the algorithm taking the weights into account.

According to a second aspect of the present invention, a process for determining an optimized route from a starting node to a destination node, comprising
i. assigning fixed weights to static route segment, wherein the values of the fixed weights are pre-assigned;
ii. assigning dynamic weights to dynamic route segment, wherein the values of the dynamic weights can be varied dynamically, and wherein the static route segments and the dynamic route segments interconnected at route nodes;
iii. determining a preferred route using a route finding algorithm, with the fixed weights taken into account;
iv. querying the dynamic weights from a data source based on the value of at least one of the previous fixed weights and dynamic weights when the route finding algorithm comes into the consideration of the dynamic route segments;
v. assigning the values of the dynamic weights obtained from the data source to the dynamic route segment; and
vi. resuming the route finding algorithm and repeating steps iv and
v until the optimized path from a starting node to a destination node is determined.

According to a third aspect of the present invention, a process for determining an optimized route from a starting node to a destination node for public transport planning and/or vehicular navigation which takes into consideration of preferred paths between multiple-station exchanges, wherein the starting node and the destination node are connected via a plurality of static route segments and a plurality of dynamic route segments, and whether the route segments are classified into a plurality of map layers, comprising
i. assigning known fixed weights to the static route segments in each map layer;
ii. assigning unknown dynamic weights to the dynamic route segments with a specific parameter in each map layer;
iii. combining a plurality of route segment graphs of all the layers into a single route segment graph;
iv. determining a preferred route using a route finding algorithm with the known fixed weights taken into account;
v. querying the unknown dynamic weights from a data source based on the value of previous weights when the route finding algorithm comes into the consideration of dynamic route segments;
vi. assigning the values of the unknown dynamic weights obtained is from the data source to the dynamic route segments; and
vii. resuming the route finding algorithm and repeating steps v and vi until the optimized path from a starting node to a destination node is determined.

According to a further aspect of the present invention, a navigation system includes
a user interface for allowing a user to enter a starting point and a destination;
an output for informing the user of an optimized route between the starting point and the destination; and
a processor for executing the following steps to determine the optimized route:
   assigning weights to route segments, the route segments interconnected at route nodes;
   varying at least a first weight relating to a first route segment by querying at least a data source based on at least a second weight relating to a second route segment, wherein the second route segment is prior to the first route segment in a consideration of the route from the starting point to the destination; and
   determining the optimized route using a route finding-algorithm, the algorithm taking the weights into account.

Other aspects and advantages of the invention will become apparent from the following detailed description, taken in conjunction with the accompanying drawings, which description illustrates byway of example the principles of the invention.

### BRIEF DESCRIPTION OF THE DRAWINGS

FIG. 1 illustrates a graph with upper and lower layers, in which an exemplary embodiment of the present invention can be used;

FIG. 2 illustrates a table and a graph with the connections between nodes of upper and lower layers of FIG. 1

FIG. 3 illustrates segments between the nodes in the upper and lower layers of FIG. 1;

FIG. 4a illustrates the query of data source, which is useful in the exemplary embodiment of the present invention;

FIG. 4b illustrates the vehicle routes between regions, in which the exemplary embodiment can also be used;

FIG. 4c illustrates the vehicle routes between regions with nodes in the lower layer of FIG. 4b;

FIG. 4d illustrates the segments in the lower layer of FIG. 4b;

FIG. 5a illustrates the segments in the upper layer of FIG. 4b;

FIG. 5b illustrates the segments between the nodes in the upper and lower layers of FIG. 5a;

FIG. 5c illustrates the vehicle routes between the regions in the upper and lower layers of FIG. 5b;

FIG. 5d illustrates the addition of parameter nodes;

FIG. 6a illustrates the addition of waiting time and duration time nodes;

FIG. 6b illustrates the addition of distance/cost nodes;

FIG. 6c illustrates the addition of combination of parameters;

FIG. 7a illustrates the segments between nodes in the upper and lower layers;

FIG. 7b illustrates the shortest paths in the lower layer;

FIG. 7c illustrates the shortest paths in the beginning segment region of the lower layer;

FIG. 7d illustrates the shortest paths in the ending segment region of the lower layer;

FIG. 7e illustrates the reconstructed model in the upper and lower layers;

FIG. 8a illustrates the shortest paths in the lower layer;

FIG. 8b illustrates the reconstructed model of the transport routes;

FIG. 9a illustrates the segments in the beginning and ending segment regions of the lower layer;

FIG. 9b illustrates the shortest paths in the lower layer;

FIG. 9c illustrates the reconstructed model in the upper and lower layers;

FIG. 10 illustrates the reconstructed model of transport routes;

FIG. 11a illustrates the reconstructed model of parameter segments;

FIG. 11b illustrates the query of dynamic/real time information;

FIG. 11c illustrates the result of the shortest path;

FIG. 12a illustrates the reconstructed model of vehicle routes;

FIG. 12b illustrates the query of dynamic/real time information;

FIG. 12c illustrates the result of the shortest transportation path; and

FIG. 13 illustrates a simplified route planning as an example for the purpose of comparison with prior designs.

### DETAILED DESCRIPTION

As shown in the Figures, in an exemplary embodiment, to handle real-time/dynamic information, additional nodes are added to the path between two nodes to represent various parameters, The added segment will obtain real-time information from data sources such as databases, web services of existing transport systems based on the weight and information of the previous starting node when applying in the shortest path algorithm.

The exemplary system is a system based on multi-layer modeling method employing shortest path algorithm at each layer. In the upper layer, possible routes between source and destination are extracted. In each path, it stores its passed nodes in the lower layer. In lower layer, shortest path algorithm is used to minimize the path between multiple nodes exchanges and the resulting shortest path will combine with routes in upper layer to reconstruct the model. After that, the reconstructed model can be plugged into shortest path algorithm to-compute the best/shortest/smallest weight route in upper layer.

Real Time Application

Examples of real time application of the present invention includes:
1. Providing real-time route planning and guidance service for passengers of public transport systems.
2. Providing real-time information such as time, distance, costs or any kinds of variable or their combinations in computing the shortest/best/smallest weight route from original location to destination.
3. Minimizing the paths during multiple stations exchanges.
4. Integrating with tourism information and city information to provide guidance about sight seeing, shopping and traveling etc.
   Definitions in Transport Route Planning

The following terms are herein defined for the purpose of the present application.

Real-time information, Weight and Parameter can be time, distance, cost or any kinds of parameter and their combinations depending on the requirements of systems or users.

Data Sources can be databases, web services or any kinds of data storage.

Data Sources Providers can be transport systems such as railway systems, vehicle systems, airline systems shipping systems or any kinds of transport information service provider.

Shortest Path Algorithm or route finding algorithm can be Dijkstra algorithm or any kinds of shortest path algorithm.

Layers can be nations, provinces, cities, districts or any kinds of location.

The model can be reused in other areas (e.g. Compute Network) to consider real-time information and minimize the multiple nodes exchanges problems in shortest path algorithm.

Data Sources

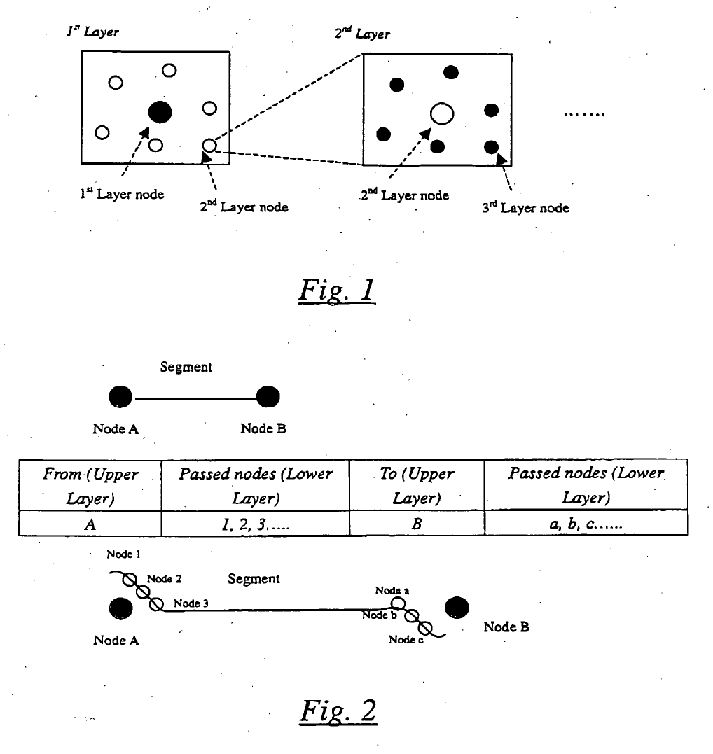

Referring to FIG. 1, the graph (map) is separated into layers, an upper layer node represents multiple nodes in the lower layer. The nodes in each layer are used to query the segments between nodes from the data sources.

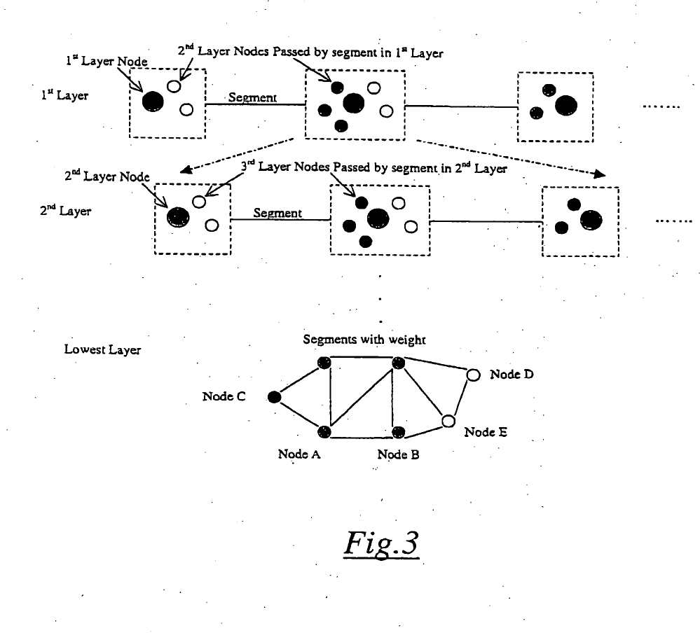

The segments between nodes are obtained through the query of data source providers. Each segment connects two nodes together with the details about the route and the passed nodes In the lower layer, as shown in FIG. 2.

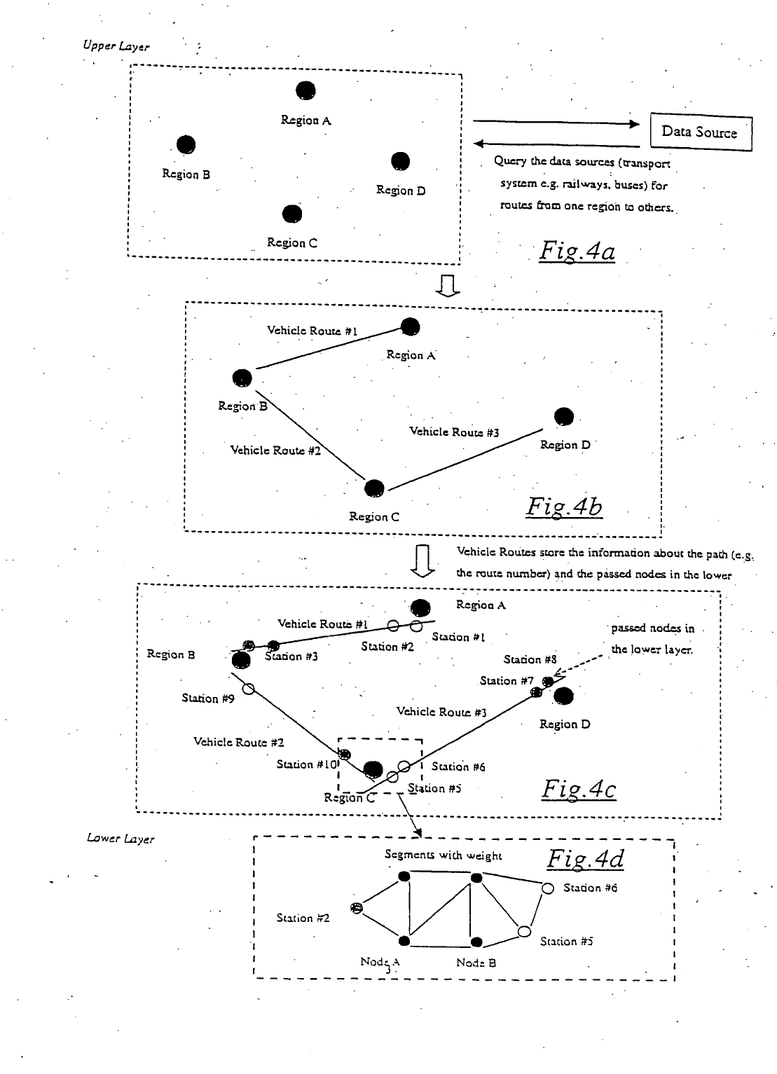

In the lowest layer, each segment connects two nodes together and stores its weight, as shown in FIG. 3.

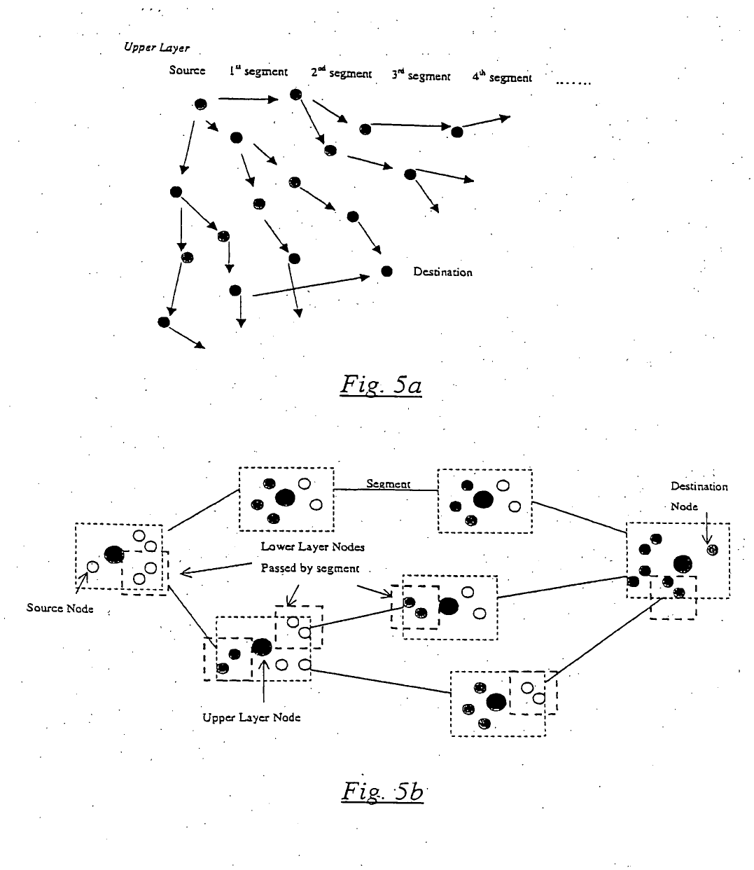

In the following example of transport route planning referring as shown in FIG. 4a to 4d, the routes between regions in upper layer are obtained through the query of the data sources of providers (e.g. railways, vehicles, airlines). The returned details about the path (e.g. route number) and passed nodes in lower layer (e.g. name and location of stations) are stored with the paths. In the lower layer, the segment represents the path within same region and node represents point of interest in that region.

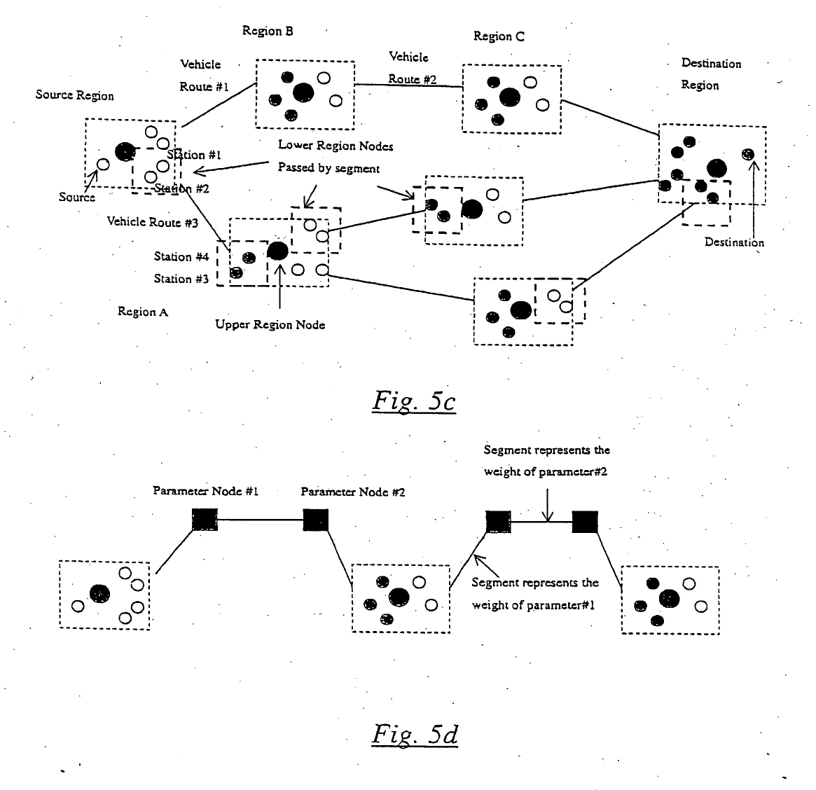

A modeling example is described, based on the lowest two layers as shown in FIGS. 5a and 5b.

Steps 1-4 are executed in the exemplary process as detailed below,

Step 1: Searching for all possible paths from the source to destination in the upper layer.

a. Searching routes from source to destination by querying the data sources.

b. Store the returned information about the path and the passed nodes in lower layer with the segments.

In public transport route planning, the routes are obtained through the query of transport systems. The returned information about the route and the passed points in lower layer are stored with the route.

Step 2: Adding an additional node for each parameter.

To handle real-time parameter (e.g. time, distance, cost etc. or their combinations), an additional node is added in the segment between two connected nodes to represent the weight of that parameter. The real-time weight of the added segment will be obtained from data source during the computation of shortest path algorithm in that layer.

This real-time information about the newly created segment is kept up-to-date and managed by the data source providers.

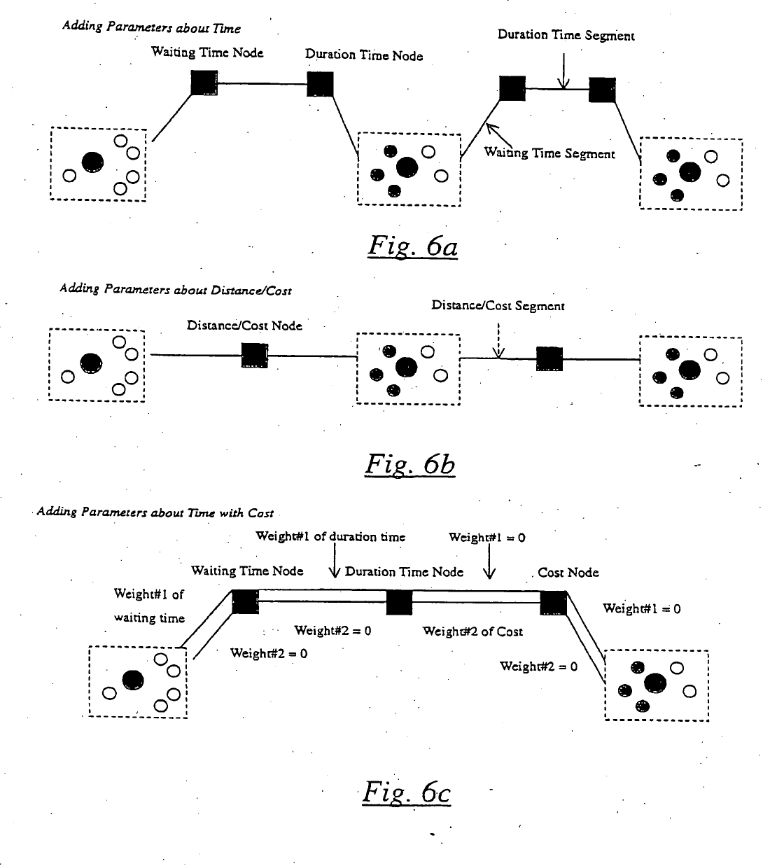

The following as shown in FIGS. 6a to 6c, is an example in transport route planning of adding parameters about time. Other parameters or their combinations can also be applied to the model depending on the requirements of systems or users.

Additional weight can be added to each segment for considering more than one parameter in shortest path algorithm. Referring to the figures, the shortest path algorithm has to store an additional parameter to determine the shortest path.

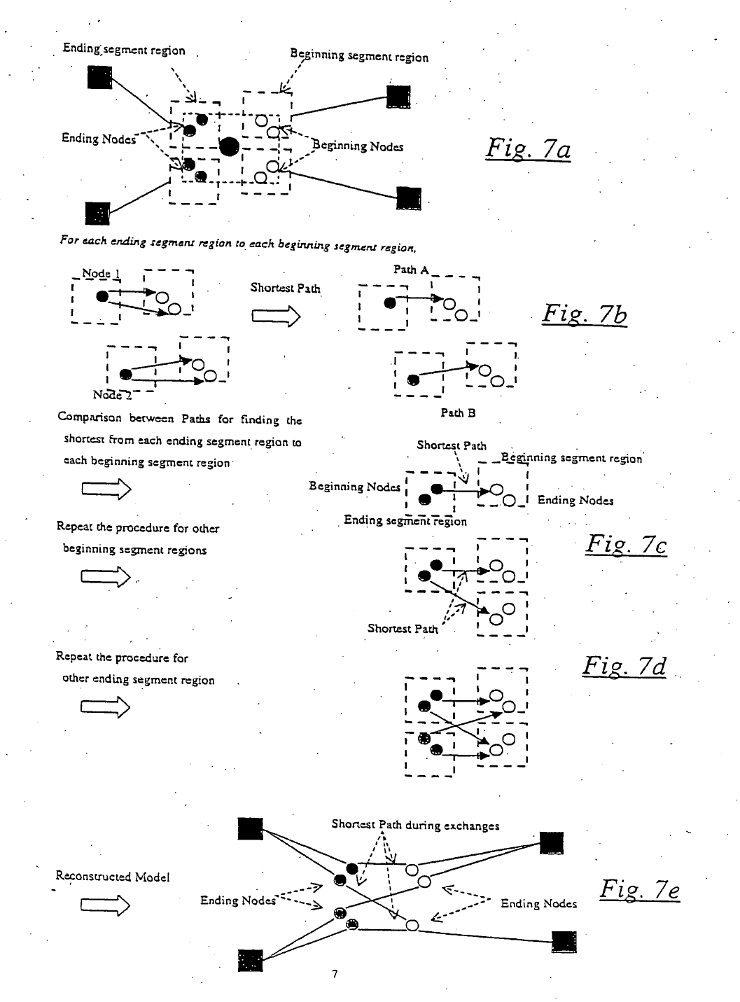

As shown in FIGS. 7a to 7e, the following will use the time parameter as an example. Other kinds of parameter can also be applied to the model with the same approach as the example using time,

Step 3:

A. Computing the shortest exchange, paths of multiple stations exchanges in lower layer.

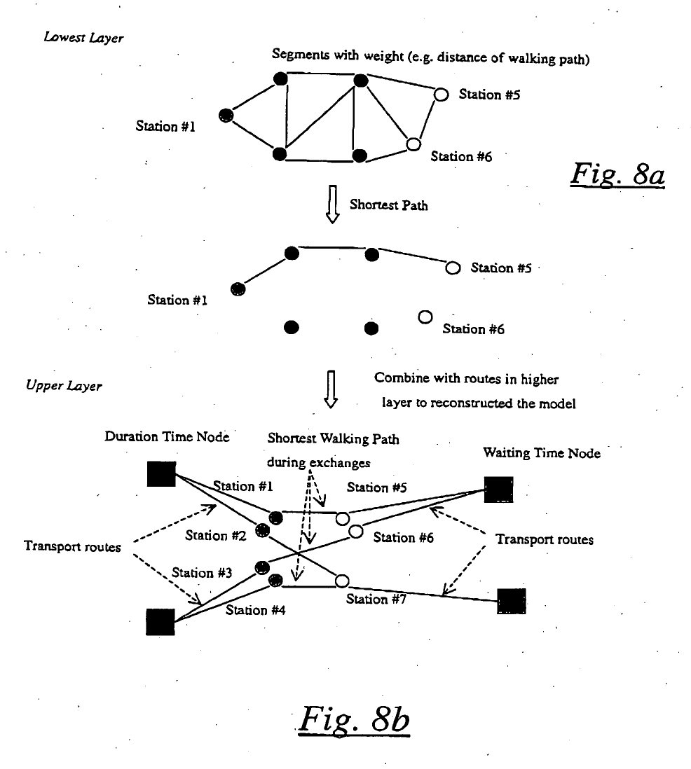

In the upper layer, the segment has the information about the passed nodes in the lower layer. Therefore, in each upper layer node, the model has a list of lower layer nodes between two connected segments. Those nodes in the lower layer connecting to the beginning of a segment called beginning nodes while those connecting to the end of a segment called ending nodes. For each ending nodes, we compute shortest/smallest weight path with the shortest path algorithm to all beginning nodes of a segment and choose the smallest one to construct a new segment connecting from the ending node to the beginning node. This procedure repeats for each beginning segment region, as shown in FIGS. 8a to 8b.

In transport route planning, the shortest/ smallest weight paths (e.g. walking paths within same region) in transport exchange are first calculated to minimize the weight of paths during exchanges and then combine with nodes in higher layer (e.g. transport route between regions) to reconstruct the model.

B. Computing the shortest path in lower layer from the source nodes to the first beginning segment region & from the last ending segment region to destination nodes.

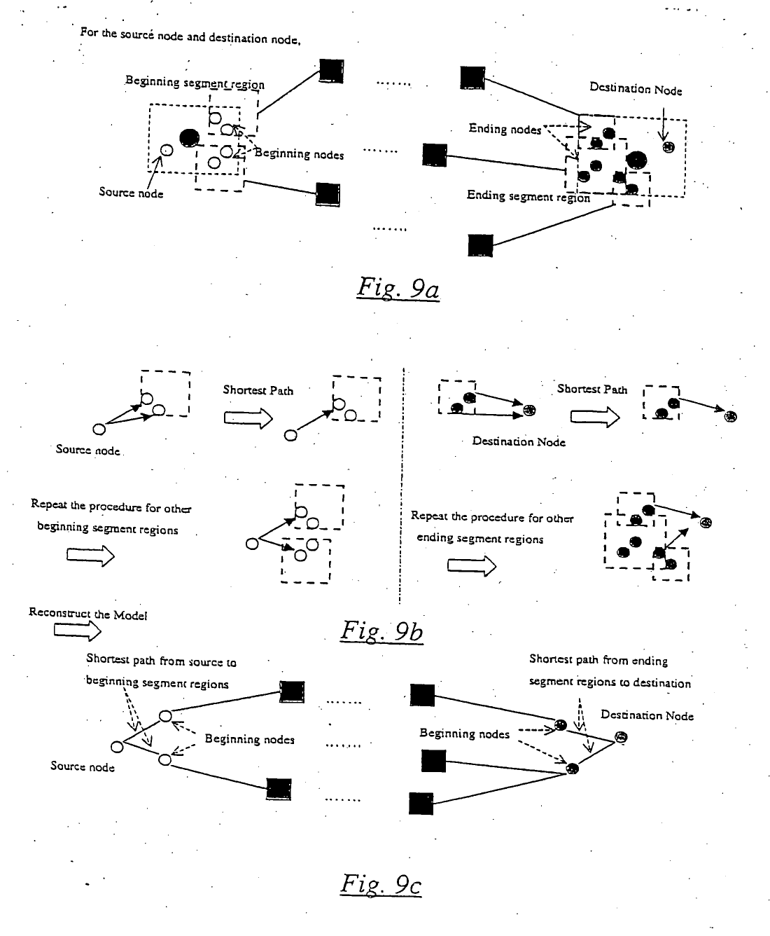

As shown in FIGS. 9a to 9c, in the lower layer, the shortest/smallest weight path from the source nodes to the all beginning segment regions and from the all ending segment regions to destination nodes are first calculated with the shortest path algorithm and then combine with nodes in higher layer to reconstruct the model.

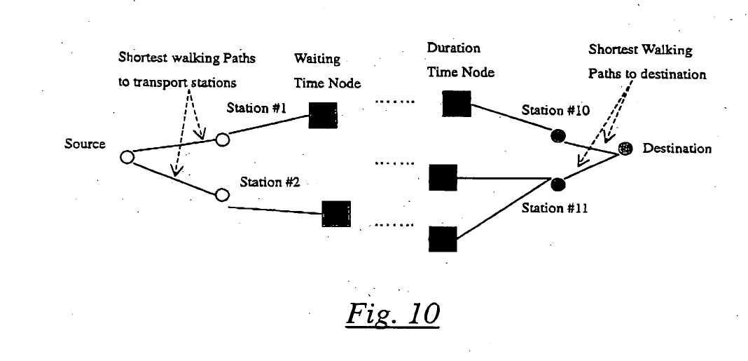

In transport route planning the shortest/smallest weight paths (e.g. walking path) from the source to the first transport station and from the last transport station to the destination are first calculated to minimize the weight of paths and then combine with nodes in higher layer (e.g. transport route) to reconstruct the model, as shown in FIG. 10.

Step 4: Plugging the model into shortest path algorithm and integrating with the real-time information and weight of segments from data source.

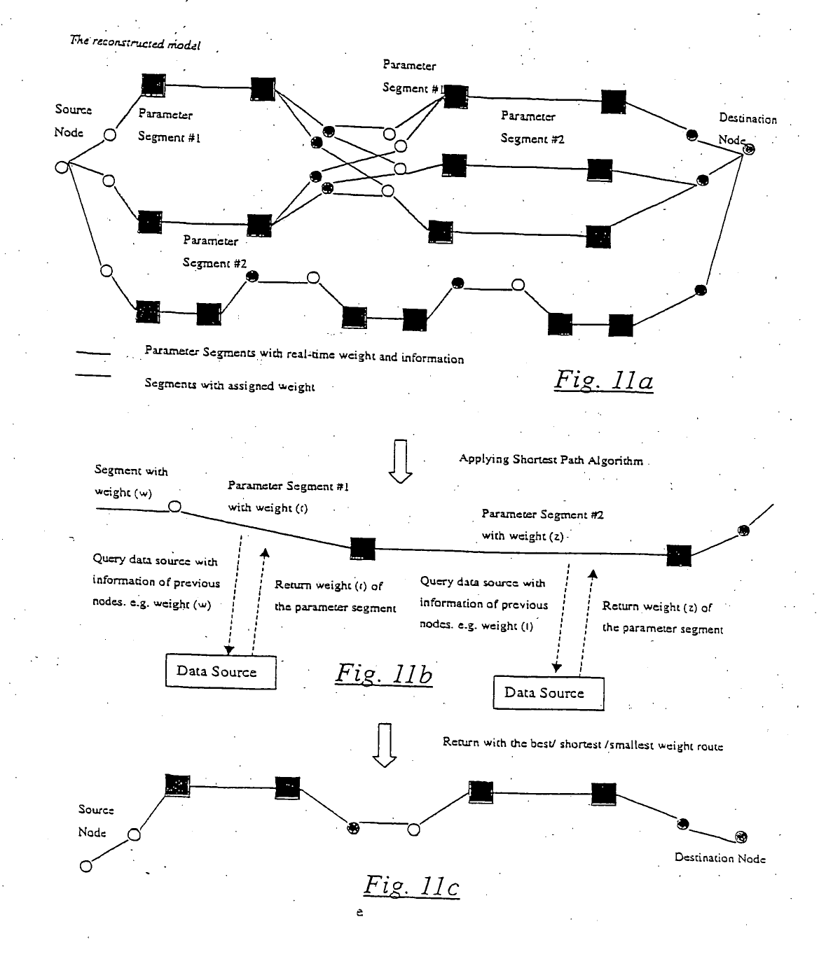

As described in FIGS. 11 a to 11 c, the reconstructed model is plugged into the shortest path algorithm. The real-time weight and information about the parameter segment are obtained through the query of the data source based on the weight and information of the previous connected node. The real-time data are kept up-to-date and managed by the data source providers.

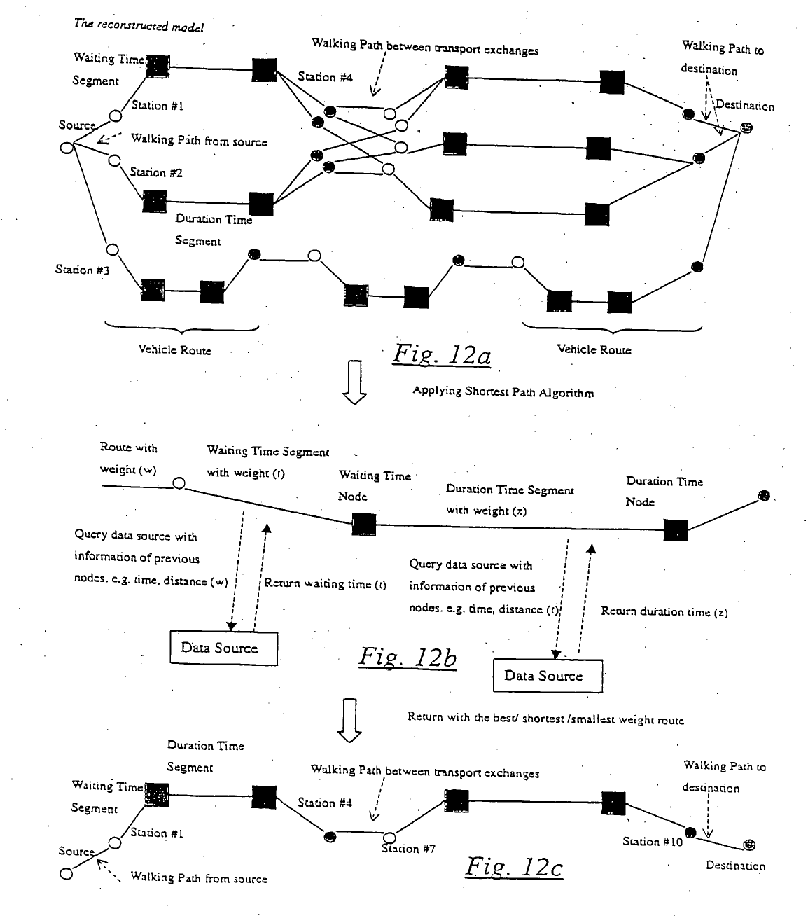

In transport route planning, for example, as shown in FIGS. 12a to 12c, the real-time weight and information about parameters segment (e.g. waiting time and duration time) are obtained through the query of the data source (e.g. databases of railway systems) based on the weight and information (e.g. time, station name, route number) of the previous connected node. The real-time data are kept up-to-date and managed by the data source providers (transport systems e.g. railway system).

Hence, the modeling method applying in the shortest path algorithm allows the consideration of real-time information about routes and minimizes the weight of paths during multiple stations exchanges in transport route planning. This provides accurate and efficient solutions to users to minimize their traveling time, cost, distance etc. or their combinations.

It is a multi-layer modeling method. The usage in transport route planning service can be extended from the use across regions to cities, provinces and nations. In a modern city, customers can easily access the detail information about public transports. With our model, this real-time information can be integrated together to provide the most efficient solutions to users. With the increasing use of mobile data services in the near future, users can access services constructed on the model to plan their transport route based on their requirements in anytime, anywhere and any devices.

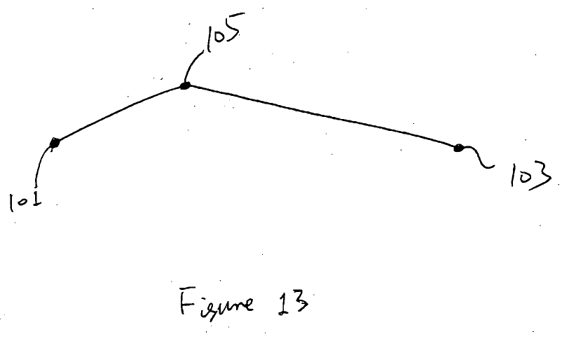

Referring to the example of FIG. 13 again, according to the exemplary embodiment of the present invention, when the user calculates the traveling time between point. 101 and point 103, the user firstly calculates the arrival time at point 105 to be 8:45 am based on the information that the traveling time from point 101 to point 105 is 30 minutes. The user then queries an external data source provided by, for example, a transportation authority and will get the information that the traveling time between point 105 and point 103 will be 30 minutes, based on the information that he arrives point 105 at 8:45 am. As a result, the user is able to accurately calculate the total traveling time from point 101 to point 103 via point 105 to be 60 minutes.

It can be understood that a computing device or a navigation system (not shown) embedding the exemplary process and having access to external data sources can be developed for the above described route planning and/or transportation navigation purposes. The user may simply enter the starting point and destination on the navigation system and triggers the route planning process. The navigation system will automatically execute the exemplified process, access the necessary external data sources, determine and present a shortest route to the user, as could be generally understood by the person in the field.

As could be appreciated by the people in the art, the route planning algorithm discussed thereabove can also be applied to computer network planning. Therefore, in the present application, the term “route” may also refer to a sequence of connections between different nodes in a computer network.

It could also be understood that the external data source, from which the user or the system queries the dynamic weights based on the value of at least one of the previous fixed weights and/or dynamic weights when the route finding algorithm comes into the consideration of the dynamic route segments can be an “internal” data source embedded in the system as well. For example, the system may include a database to keep track the position of buses using GPS.

What is claimed is:

1. A process for determining a route from a predetermined starting point to a predetermined destination, comprising:
assigning weights to route- segments, the route segments interconnected at route nodes;
varying at least a first weight relating to a first route segment by querying at least a data source based on at least a second weight relating to a second route segment, wherein the second route segment is prior to the first route segment in a consideration of the route from the starting point to the destination; and
determining the route using a route finding algorithm, the algorithm taking the weights into account.

2. A process for determining an optimized route from a starting node to a destination node, comprising
i. assigning fixed weights to static route segments, wherein the values of the fixed weights are pre-assigned;
ii. assigning dynamic weights to dynamic route segments, wherein the values of the dynamic weights can be varied dynamically, and wherein the static route segments and the dynamic route segments interconnected at route nodes;
iii. determining a preferred route using a route finding algorithm, with the fixed weights taken into account;
iv. querying the dynamic weights from a data source based on the value of at least one of the previous fixed weights and dynamic weights when the route finding algorithm comes into the consideration of the dynamic route segments;
v. assigning the values of the dynamic weights obtained from the data source to the dynamic route segments; and
vi. resuming the route finding algorithm and repeating steps iv and v until the optimized path from a starting node to a destination node is determined.

3. The process of claim 2, wherein the dynamic weights of the route segments in graph are assigned as a function of weights of the previous route segments.

4. The process of claim 2, wherein the weights can be time, distance, cost or their combinations.

5. The process of claim 2, wherein the route finding algorithm is Dijkstra algorithm.

6. A process for determining an optimized route from a starting node to a destination node for public transport planning and/or vehicular navigation which takes into consideration of preferred paths between multiple-station exchanges, wherein the starting node and the destination node are connected via a plurality of static route segments and a plurality of dynamic route segments, and whether the route segments are classified into a plurality of map layers, comprising
i. assigning known fixed weights to the static route segments in each map layer;
ii. assigning unknown dynamic weights to the dynamic route segments with a specific parameter in each map layer;
iii, combining a plurality of route segment graphs of all the layers into a single route segment graph;
iv. determining a preferred route using a route finding algorithm with the known fixed weights taken into account;
v. querying the unknown dynamic weights from a data source based on the value of previous weights when the route finding algorithm comes into the consideration of dynamic route segments;
vi. assigning the values of the unknown dynamic weights obtained from the data source to the dynamic route segments; and
vii. resuming the route finding algorithm and repeating steps v and vi until the optimized path from a starting node to a destination node is determined.

7. The method according to claim 6, wherein the map layers are separated according to a coverage of various means of transportations.

8. The method according to claim 7, the coverage can be classified into, region, district, intra-city or inter-city.

9. The process of claim 6, wherein the route finding algorithm is Dijkstra algorithm.

10. A navigation system, comprising
a user interface for allowing a user to enter a starting point and a destination;
an output for informing the user of an optimized route between the starting point and the destination; and
a processor for executing the following steps to determine the optimized route:
assigning weights to route segments, the route segments interconnected at route nodes;
varying at least a first weight relating to a first route segment by querying at least a data source based on at least a second weight relating to a second route segment, wherein the second route segment is prior to the first route segment in a consideration of the route from the starting point to the destination; and
determining the optimized route using a route finding algorithm, the algorithm taking the weights into account.
